(19) United States
(12) Patent Application Publication
(10) Pub. No.: US 2009/0120793 A1
(43) Pub. Date: May 14, 2009

(54) METHOD OF PROTONATING HYDROGEN MOLECULE, CATALYST FOR PROTONATING HYDROGEN MOLECULE, AND HYDROGEN GAS SENSOR

(75) Inventors: Jin MIZUGUCHI, Yokohama-Shi (JP); Hiroo Takahashi, Yokohama-shi (JP); Tomomitsu Yamanishi, Higashiomi-shi (JP); Junichi Suzuki, Omihachiman-shi (JP); Hiroshi Takagi, Otsu-shi (JP); Noboru Tanida, Higashiomi-shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: MURATA MANUFACTURING CO., LTD., Nagaokakyo-Shi (JP)

(21) Appl. No.: 12/045,675

(22) Filed: Mar. 10, 2008

(30) Foreign Application Priority Data
Mar. 9, 2007 (JP) 2007-060517

(51) Int. Cl. G01N 27/407; C01B 3/00

(52) U.S. Cl. 204/424; 423/648.1

(57) ABSTRACT

A method of protonating a hydrogen molecule includes bringing hydrogen gas into contact with a surface of a solid having a relative dielectric constant of more than 78.

### BACKGROUND OF THE INVENTION

1. Field of the Invention

The present invention relates to a method of protonating a hydrogen molecule and a catalyst for protonating a hydrogen molecule. Furthermore, the present invention relates to a hydrogen gas sensor.

2. Description of the Related Art

Phosphoric acid fuel cells and solid polymer electrolyte fuel cells are promising clean power generating systems that operate at relatively low temperatures. In particular, solid polymer electrolyte fuel cells have been developed as a power source for movable objects such as automobiles. Hydrogen gas is supplied to the anode of these fuel cells. The hydrogen is oxidized by a catalyst in the anode to generate protons and electrons. This catalyst is essential to the fuel cells, and a noble metal such as platinum or palladium is generally used as the catalyst.

Japanese Unexamined Patent Application Publication No. 2004-158290 discloses a solid polymer electrolyte fuel cell including an electrode catalyst layer including hollow fibrous carbon on which noble metal particles are supported and a hydrogen-ion conductive polymer electrolyte.

A known hydrogen gas sensor includes an organic pigment whose electrical resistivity is significantly changed by addition of a proton (refer to Japanese Unexamined Patent Application Publication No. 2006-276029). This sensor also includes fine platinum or palladium as a catalyst for protonating a hydrogen molecule. In addition, glass is used as a substrate of the sensor.

In the fuel cell disclosed in, for example, Japanese Unexamined Patent Application Publication No. 2004-158290, a noble metal such as platinum is used as a catalyst for protonating hydrogen. However, a noble metal such as platinum is expensive, and the amount of such noble metal reserves is small. These problems hinder the fuel cell from being widely used. Accordingly, a novel catalyst for protonating the hydrogen, the catalyst replacing a noble metal, has been desired.

The hydrogen gas sensor disclosed in Japanese Unexamined Patent Application Publication No. 2006-276029 also includes a platinum catalyst for protonating hydrogen. Although the amount of platinum used is relatively small in the hydrogen gas sensor, an improvement in the performance of the sensor by use of a novel catalyst has been desired.

### SUMMARY OF THE INVENTION

Accordingly, it is an object of the present invention to provide a novel catalyst for protonating a hydrogen molecule, the novel catalyst replacing a noble metal such as platinum.

To solve the above problems, a method of protonating hydrogen according to an embodiment of the present invention includes bringing hydrogen gas into contact with a surface of a solid having a relative dielectric constant of more than 78.

A catalyst for protonating hydrogen according to an embodiment of the present invention is a solid having a relative dielectric constant of more than 78.

A hydrogen gas sensor according to an embodiment of the present invention includes a substrate made of a solid having a relative dielectric constant of more than 78; and a proton-accepting layer that is provided on the substrate and that is made of an organic compound whose electrical resistivity, photoconductivity or optical absorption band can be changed by addition of a proton.

Furthermore, a hydrogen gas sensor according to an embodiment of the present invention includes a substrate made of a solid having a relative dielectric constant of more than 78; at least one pair of electrodes provided on the substrate; and a proton-accepting layer that is provided so as to cover the at least one pair of electrodes and that is made of an organic compound whose electrical resistivity can be changed by addition of a proton.

It is known that the energy required to bind an electron to a positive charge (binding energy) is inversely proportional to the square of the dielectric constant of a medium. For example, in a system (an n-type semiconductor) in which (pentavalent) phosphorus (P) is doped as an impurity in a (tetravalent) silicon (Si) semiconductor, an electron is separated and dissociated from the binding of P⁺ with an energy smaller than that required in vacuum. More specifically, since the relative dielectric constant of Si is about 12, the binding energy is decreased to about 1/144 of that in vacuum.

It is believed that an advantage of the present invention can be achieved by the same action. Specifically, when hydrogen gas is brought into contact with a surface of a solid having a relative dielectric constant of more than 78, the binding energy between hydrogen atoms and/or the binding energy between a proton and an electron is decreased. Consequently, a proton is easily produced compared with a case in a medium having a relative dielectric constant of 78 or less (for example, in vacuum or in water).

In a method of protonating a hydrogen molecule according to an embodiment of the present invention, the binding energy between hydrogen atoms and/or the binding energy between a proton and an electron can be decreased. Therefore, a hydrogen molecule can be protonated without using a noble metal, which is expensive and the amount of reserves of which is small, or by using a small amount of a noble metal.

In a hydrogen gas sensor according to an embodiment of the present invention, the binding energy between hydrogen atoms and/or the binding energy between a proton and an electron can be decreased. As a result, the speed of a reaction in which protons are produced from hydrogen gas and the speed of a reverse reaction thereof can be increased. Accordingly, the rising speed and the falling speed in the gain-time characteristic of the hydrogen gas sensor can be improved compared with the gain-time characteristic of a known hydrogen gas sensor including a glass substrate.

Other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a schematic view illustrating the experiment of Example 1 of the present invention;

FIGS. 2A and 2B are top and cross-sectional views showing the structure of a hydrogen gas sensor according to an embodiment of the present invention; and

FIG. 3 is a graph showing the results of Example 2 of the present invention.

### DESCRIPTION OF THE PREFERRED EMBODIMENTS

Various materials can be selected as a substance having a relative dielectric constant of more than 78. An example thereof is a high dielectric constant ceramic composition disclosed in Japanese Examined Patent Application Publication No. 1-18521. Specifically, the high dielectric constant ceramic composition contains 1.0 to 2.5 parts by weight of Nb₂O₅, 0.1 to 0.8 parts by weight of CO₂O₃, 0.1 to 1.2 parts by weight of SiO₂, and 0.3 to 1.0 part by weight of at least one rare-earth oxide selected from Nd₂O₃, La₂O₃, and Pr₆O₁₁ relative to 100 parts by weight of barium titanate containing 0.04 weight percent or less of an alkali metal oxide as an impurity. In addition, ceramic compositions in which a part of barium titanate in the above composition is substituted with barium zirconate and ceramic compositions containing Bi₂O₃, SnO₂, ZrO₂, MgO, or FeO as an auxiliary component can also be used. Substances having a relative dielectric constant in the range of about 1,000 to 10,000 at room temperature can be easily obtained by appropriately selecting the composition.

In a method of protonating a hydrogen molecule according to an embodiment of the present invention described above, hydrogen gas is brought into contact with a surface of a solid having a relative dielectric constant of more than 78. This method can be used for a fuel cell. For example, instead of a noble metal catalyst or in addition to a noble metal catalyst, a powder made of a substance having a relative dielectric constant of more than 78 can be supported on acetylene black or the like. In this case, when a ceramic powder that is heat-treated at a temperature significantly exceeding the operation temperature of a normal fuel cell, for example, at a high temperature of about 1,000° C. or higher, is used as the solid having a relative dielectric constant of more than 78, protonation can be accelerated, and in addition, the ceramic powder is not agglomerated during use. Thus, the use of such a ceramic powder contributes to an increase in the lifetime of the fuel cell.

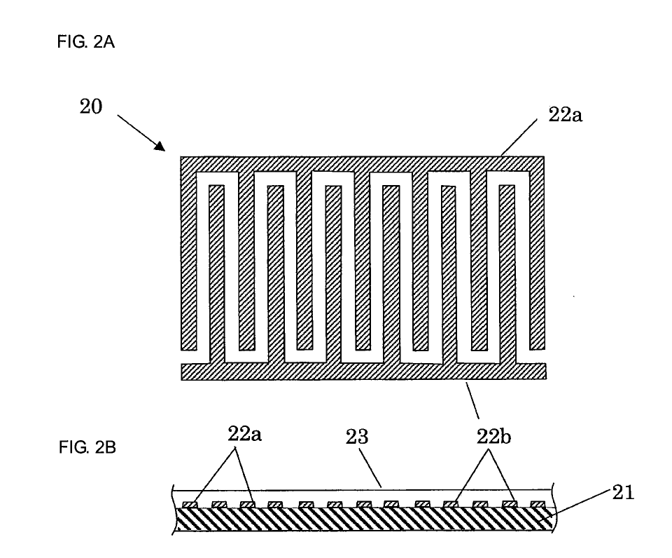

The method of protonating a hydrogen molecule according to an embodiment of the present invention can also be used for a hydrogen gas sensor. A hydrogen sensor having the same structure as that disclosed in Japanese Unexamined Patent Application Publication No. 2006-276029 can be used as the hydrogen gas sensor. More specifically, as shown in FIG. 2, comb-shaped electrodes 22a and 22b are arranged on a substrate 21 so as to face each other in a hydrogen gas sensor 20. Platinum (Pt) (thickness: about several angstroms) (not shown) functioning as a catalyst is deposited on the electrodes or between the electrodes in the form of islands by sputtering. An organic compound whose electrical resistivity, photoconductivity, or optical absorption band can be changed by addition of a proton is further formed thereon in the form of a film by vacuum deposition, thus forming a proton-accepting layer 23.

The organic compound constituting the proton-accepting layer 23 is an organic pigment having a heterocyclic ring containing a nitrogen atom. Examples of the organic pigment include quinacridone, indigo, phthalocyanine, anthraquinone, indanthrone, anthanthrone, perylene, pyrazolone, perinone, isoindolinone, dioxazine, and derivatives thereof. The heterocyclic ring containing a nitrogen atom is preferably a pyridine-based heterocyclic ring.

Various types of materials can be used for the comb-shaped electrodes. Examples thereof include aluminum (Al), indium-tin-oxide (ITO), gold (Au), silver (Ag), palladium (Pd), platinum (Pt) and a palladium-platinum (Pd—Pt) alloy.

An electric field of about 10⁵ V/cm is applied between the electrodes of the comb-shaped electrodes so that hydrogen molecules easily dissociate into hydrogen atoms. Since the Pt catalyst is provided in the form of islands, short circuits do not occur between the electrodes. The Pt catalyst may be disposed inside the proton-accepting layer 23 or on the surface of the proton-accepting layer 23 as long as the Pt catalyst is provided in the form of islands.

Furthermore, a substance having a relative dielectric constant of more than 78 is used as the material of the substrate 21. Accordingly, when hydrogen gas is introduced into the hydrogen gas sensor 20, the surface of the substrate 21 functions as a catalyst.

### Example 1

This Example 1 describes the protonation of a hydrogen molecule performed by bringing hydrogen gas into contact with a powdery solid having a relative dielectric constant of more than 78.

First, two types of dielectric material powders used as a catalyst were prepared. A first powder contained 0.9 parts by weight of Nb₂O₅, 0.2 parts by weight of CO₂O₃, 0.6 parts by weight of SiO₂, and 0.6 part by weight of Nd₂O₃ relative to 100 parts by weight of BaTiO₃ containing 0.04 weight percent or less of an alkali metal oxide as an impurity.

This dielectric material powder was produced as follows. First, BaCO₃ and TiO₂, which were used as starting materials, were mixed and heat-treated to synthesize barium titanate. Subsequently, Nb₂O₅, CO₂O₃, SiO₂, and Nd₂O₃ were added so that the mixture had a predetermined ratio. Mixing was performed again, and the mixture was compacted, heat-treated, and then crushed. The heat-treatment temperature for synthesizing barium titanate was 1,150° C., and the heat-treatment temperature performed after the addition of the auxiliary components was 1,230° C. The resulting powder had an average particle diameter of about 5 μm.

Silver (Ag) electrodes were provided on a disc-shaped sintered body obtained before the crushing to prepare a capacitor. The measured value of the relative dielectric constant of the resulting material was 3,500 at room temperature.

A second dielectric powder had a composition of (Ba_{0.898}Ca_{0.100}Mg_{0.002}) (Ti_{0.880}Sn_{0.055}Zr_{0.065}) O₃.

This dielectric material powder was produced as follows. First, BaCO₃, TiO₂ CaCO₃, MgCO₃, ZrO₂ and SnO₂, all of which were used as starting materials, were prepared so that the resulting mixture had a predetermined ratio. These starting materials were mixed and calcined to synthesize (Ba_{0.898}Ca_{0.100} Mg_{0.002}) (Ti_{0.880}Sn_{0.055}Zr_{0.065}) O₃. The calcined powder was compacted, sintered, and then crushed. The calcination temperature for the synthesis was 1,150° C., and the sintering temperature was 1,350° C. The resulting powder had an average particle diameter of about 5 μm.

Silver (Ag) electrodes were provided on a disc-shaped sintered body obtained before the crushing to prepare a capacitor. The measured value of the relative dielectric constant of the resulting material was 10,000 at room temperature.

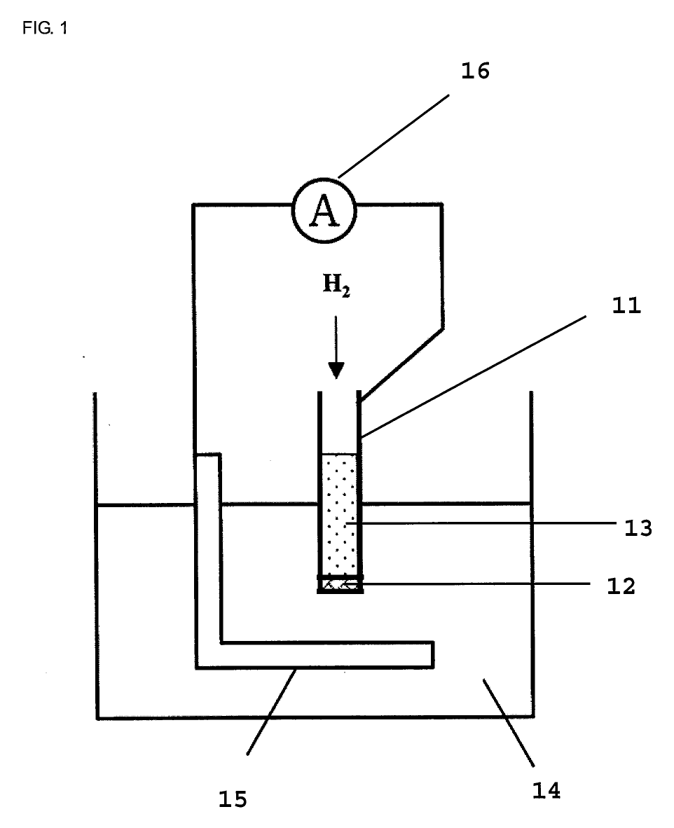

The arrangement of a device used in an experiment will now be described with reference to FIG. 1.

A porous disc 12 (thickness: 1 mm) having a porosity of about 50% was attached to the bottom of a glass tube 11 having a length of 50 mm and a diameter of 8 mm using an adhesive mainly composed of an epoxy resin. An aluminum (Al) film was formed on the surface of the porous disc 12 and the outer surface of the glass tube 11 by vacuum deposition, thus providing electron conductivity. The glass tube 11 was filled with a dielectric material powder 13, prepared as described above, to a height of 30 mm.

The tip of the glass tube 11 was immersed 15 mm in deionized water 14, and aluminum (Al) was used as a counter electrode 15. The part of the glass tube 11 on which aluminum (Al) was deposited was connected to the counter electrode 15 using a conducting wire, with an ammeter 16 therebetween.

In the experiment, the current value was measured in the case where hydrogen gas was introduced into the glass tube 11 at a flow rate of 2 mL/min and the case where nothing was introduced into the glass tube 11. When hydrogen gas was introduced, the hydrogen gas was brought into contact with the surface of the dielectric material powder 13 having a relative dielectric constant of 3,500 or 10,000. For comparison, the experiment was performed under the condition that no dielectric material powder was placed in the glass tube 11. In this comparative experiment, the medium surrounding the hydrogen gas was water (relative dielectric constant: 78). In another comparative experiment, platinum (Pt) was deposited on the outer surface of an aluminum tube by sputtering. This comparative experiment was performed under the condition that no dielectric material powder was placed in the aluminum tube.

Table 1 shows the experimental results. Regarding the current values shown in Table 1, the direction in which a current flows from the glass tube 11 to the counter electrode 15 via the ammeter 16 is represented by a positive value, and the reverse direction thereof is represented by a negative value. The values of current density were calculated by dividing a current value by an area (3.8 cm²) of a portion of the electron-conductive part made of aluminum (Al) or platinum (Pt), the portion being immersed in water.

TABLE 1

| | | With introduction | | Without introduction | |
|---|---|---|---|---|---|
| | Relative | of hydrogen gas | | of hydrogen gas | |
| | dielectric | Current | Current | Current | Current |
| Electron | constant | value | density | value | density |
| conductor | of medium | (μA) | (μAcm⁻²) | (μA) | (μAcm⁻²) |
| Al | 78 | 0.28 | 0.074 | 0.30 | 0.079 |
| Al | 3,500 | 0.68 | 0.18 | −0.15 | −0.040 |
| Al | 10,000 | 0.68 | 0.18 | −0.46 | −0.12 |
| Pt | 78 | 0.95 | 0.25 | −0.87 | −0.23 |

Referring to Table 1, the current values were substantially the same regardless of the introduction of hydrogen gas in the case where nothing was placed in the glass tube 11. In contrast, where the dielectric material powder 13 having a relative dielectric constant of 3,500 or 10,000 was filled in the glass tube 11, the direction of the current was reversed by introducing hydrogen gas. In particular, when the dielectric material powder having a relative dielectric constant of 10,000 was used, the current value was substantially the same as that in the case where platinum (Pt), which is a commonly used catalyst. It is believed that introduced hydrogen gas contacted the surface of the dielectric material powder 13, thereby the binding energy of the hydrogen gas decreased and the hydrogen gas dissociated into protons and electrons.

½H₂→H⁺+e⁻

It is believed that the current was generated as a result of the electrons being produced together with the protons that flowed to the counter electrode via an external circuit.

From the standpoint of protonation of a hydrogen molecule, the method of bringing hydrogen gas into contact with a surface of a solid (dielectric material powder) having a relative dielectric constant of 3,500 or 10,000 is superior to the method of allowing hydrogen gas to pass through a medium (water) having a relative dielectric constant of 78. The relative dielectric constant is not limited to 3,500 or 10,000, and this effect can be achieved as long as hydrogen gas is brought into contact with a surface of a solid having a relative dielectric constant of more than 78, though the degree of the effect is different.

### Example 2

Next, a hydrogen gas sensor according to Example 2 of the present invention will now be described.

In preparation of a hydrogen gas sensor 20 having the structure shown in FIGS. 2A and 2B, the material of a substrate 21 was the same composition as that of the first dielectric material powder used in Example 1, having relative dielectric constant of 3,500. Comb-shaped electrodes 22a and 22b were made of ITO. Platinum (Pt) (thickness: about several angstroms) (not shown) functioning as a catalyst was deposited on the comb-shaped electrodes 22a and 22b by sputtering in the form of islands. Furthermore, pyrrolopyrrole (which contains a pyridine ring) was deposited thereon by vacuum deposition in the form of a film to form a proton-accepting layer 23. The width of each electrode and the distance between electrodes in the comb-shaped electrodes 22a and 22b were 100 μm.

For comparison, a hydrogen gas sensor including a substrate 21 made of glass having a relative dielectric constant of 6 was prepared.

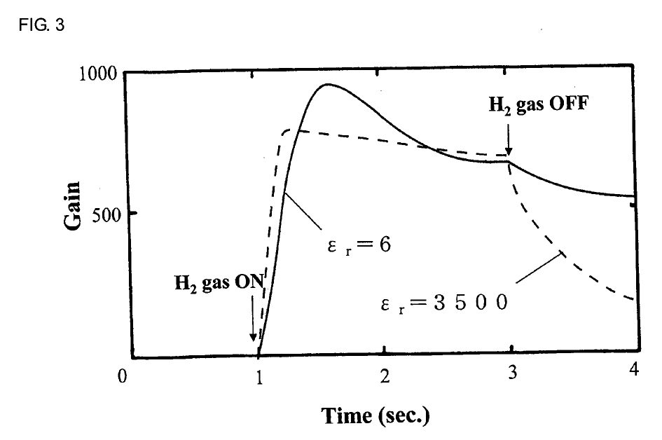

An electric field of 10⁵ V/cm was applied between the electrodes of the comb-shaped electrodes, and the value of current flowing between the electrodes was measured. One second after the start of the measurement, hydrogen gas was introduced, and three seconds after the start of the measurement, the introduction of hydrogen gas was stopped. FIG. 3 shows the results. In FIG. 3, the broken line denotes the result of the case where the substrate of this example having a relative dielectric constant of 3,500 was used, and the solid line denotes the results of the case where the substrate for comparison having a relative dielectric constant of 6 was used.

As is apparent from FIG. 3, the rising speed in the gain-time characteristic when hydrogen gas was introduced and the falling speed when the introduction of the hydrogen gas was stopped were improved in the case where the substrate having a relative dielectric constant of 3,500 was used, compared with the case where the substrate having a relative dielectric constant of 6 was used. This is because the binding energy between hydrogen atoms and/or the binding energy between a proton and an electron is decreased. The relative dielectric constant is not limited to 3,500, and this effect can be achieved as long as a solid having a relative dielectric constant of more than 78 is used as the substrate, though the degree of the effect is different.

While preferred embodiments of the invention have been described above, it is to be understood that variations and modifications will be apparent to those skilled in the art without departing the scope and spirit of the invention. The scope of the invention, therefore, is to be determined solely by the following claims.

What is claimed is:

1. A method of protonating a hydrogen molecule comprising:
contacting hydrogen gas with a surface of a solid having a relative dielectric constant of more than 78.

2. The method of protonating a hydrogen molecule according to claim 1 in which the solid has a relative dielectric constant of at least about 1,000.

3. The method of protonating a hydrogen molecule according to claim 2 in which the solid has a relative dielectric constant of about 3,500 to 10,000.

4. The method of protonating a hydrogen molecule according to claim 1 in which the solid comprises barium titanate.

5. The method of protonating a hydrogen molecule according to claim 1 in which the solid comprises 100 parts by weight barium titanate containing 0.04 weight percent or less of an alkali metal oxide as an impurity, 1.0 to 2.5 parts by weight of Nb₂O₅, 0.1 to 0.8 parts by weight of Co₂O₃, 0.1 to 1.2 parts by weight of SiO₂, and 0.3 to 1.0 part by weight of at least one rare earth oxide selected from Nd₂O₃, La₂O₃, and Pr₆O₁₁.

7. A hydrogen gas sensor comprising:
a substrate comprising a solid having a relative dielectric constant of more than 78; and
a proton-accepting layer disposed on the substrate and comprising an organic compound whose electrical resistivity, photoconductivity or optical absorption band can be changed by addition of a proton.

8. A hydrogen gas sensor according to claim 7 comprising a pair of electrodes provided on the substrate; and wherein the proton-accepting layer covers the pair of electrodes and comprises an organic compound whose electrical resistivity can be changed by addition of a proton.

9. The hydrogen gas sensor according to claim 8 in which the solid has a relative dielectric constant of at least about 1,000.

10. The hydrogen gas sensor according to claim 9 in which the solid has a relative dielectric constant of about 3,500 to 10,000.

11. The hydrogen gas sensor according to claim 8 in which the solid comprises barium titanate.

12. The hydrogen gas sensor according to claim 8 in which the solid comprises 100 parts by weight barium titanate containing 0.04 weight percent or less of an alkali metal oxide as an impurity, 1.0 to 2.5 parts by weight of Nb₂O₅, 0.1 to 0.8 parts by weight of Co₂O₃, 0.1 to 1.2 parts by weight of SiO₂, and 0.3 to 1.0 part by weight of at least one rare-earth oxide selected from Nd₂O₃, La₂O₃, and Pr₆O₁₁.

13. A hydrogen gas sensor according to claim 8, wherein the proton-accepting layer comprises an organic pigment containing a nitrogen-containing ring.

14. A hydrogen gas sensor according to claim 8, wherein there are discontinuous noble metal islands disposed on the substrate.

15. The hydrogen gas sensor according to claim 7 in which the solid has a relative dielectric constant of at least about 1,000.

16. The hydrogen gas sensor according to claim 15 in which the solid has a relative dielectric constant of about 3,500 to 10,000.

17. The hydrogen gas sensor according to claim 7 in which the solid comprises barium titanate.

18. The hydrogen gas sensor according to claim 7 in which the solid comprises 100 parts by weight barium titanate containing 0.04 weight percent or less of an alkali metal oxide as an impurity, 1.0 to 2.5 parts by weight of Nb₂O₅, 0.1 to 0.8 parts by weight of CO₂O₃, 0.1 to 1.2 parts by weight of SiO₂, and 0.3 to 1.0 part by weight of at least one rare-earth oxide selected from Nd₂O₃, La₂O₃, and Pr₆O₁₁.

19. A hydrogen gas sensor according to claim 7, wherein the proton-accepting layer comprises an organic pigment containing a nitrogen-containing ring.

20. A hydrogen gas sensor according to claim 7, wherein there are discontinuous noble metal islands disposed on the substrate.
